(19) United States
(12) Patent Application Publication
(10) Pub. No.: US 2025/0086729 A1
(43) Pub. Date: Mar. 13, 2025

(54) System and Method for Processing Forms 4684 Casualties, Disasters and Thefts

(71) Applicant: Joe Jenkins, Silver Spring, MD (US)

(72) Inventor: Joe Jenkins, Silver Spring, MD (US)

(21) Appl. No.: 18/466,270

(22) Filed: Sep. 13, 2023

(51) Int. Cl. G06Q 40/12

(52) U.S. Cl. CPC G06Q 40/123

(57) ABSTRACT

A system and method for processing tax forms and schedules [Forms 4684 Baskets] in compliance with IRS Publication 547, Casualties, Disasters and Thefts are enclosed. The system may include a method for the receipt of mailed and electronically submitted tax forms and schedules. The system may also include both current year and amended tax forms and schedules to allow for the submission and processing of specific taxpayer's forms and schedules. For example, the amended tax forms and schedules [i.e., 1040X, 1065X, 1120X and 1120S] are submitted to receive a tax refund resulting from losses incurred by the taxpayers as Publication 547 allows taxpayers to carry back certain losses to the prior tax year. The system and method may be implemented and operated supporting current IRS facilities and staff, systems, and software.

### CROSS-REFERENCE TO RELATED APPLICATIONS

Provisional Application No. 63/241,220

### STATEMENT REGARDING FEDERALLY SPONSORED RESEARCH OR DEVELOPMENT

N/A

### REFERENCE TO A “SEQUENCE LISTING”

N/A

### BACKGROUND OF THE INVENTION

The IRS requires taxpayers experiencing Federally declared casualties, disasters and thefts, gains, or losses to report using Form 4684 “Casualties, Disasters and Thefts”. Those taxpayers with losses from Federally declared disasters may elect to report losses in the prior tax year by submitting required forms and schedules in accordance with Publication 547, Casualties, Disasters, and Thefts. The turnaround for resultant refunds for those taxpayers that elect to report disasters losses in the prior tax year exceeds 60 days. The delay in receiving these refunds can result in critical and prolonged financial consequences for these taxpayers. Thus, reducing this turnaround would be a major factor contributing to the taxpayer's recovery time and welfare. The system and method proposed in this titled invention offers the IRS an opportunity to reduce turnaround time; precludes a need to outsource to other sources, particularly overseas; assistance with their massive tax returns processing responsibility, and, create an off-budget financing source. The system and method are subject to an award pursuant to OMB Circular A-76. Performance of Commercial Activities.

### BRIEF SUMMARY OF INVENTION

The titled invention provides for the receipt and processing of tax returns submitted electronically and by mail. It includes the creation of a shared workspace between the IRS and Recipient for the evaluation and approval, statistical sampling, and data generation of submitted Forms 4684. Additionally, a cooperative agreement would be established with a financial with a mutual goal and arrangement between the IRS and the Recipient to jointly make periodic contributions to a reserve account over a projected period to make future costs for this method and process self-sustaining. The process presented here will provide the IRS with substantial cost savings and reduce the period between taxpayer submissions of Forms 4684 for losses submitted for prior year recognition.

### BRIEF DESCRIPTION OF DRAWINGS [DIAGRAMS]

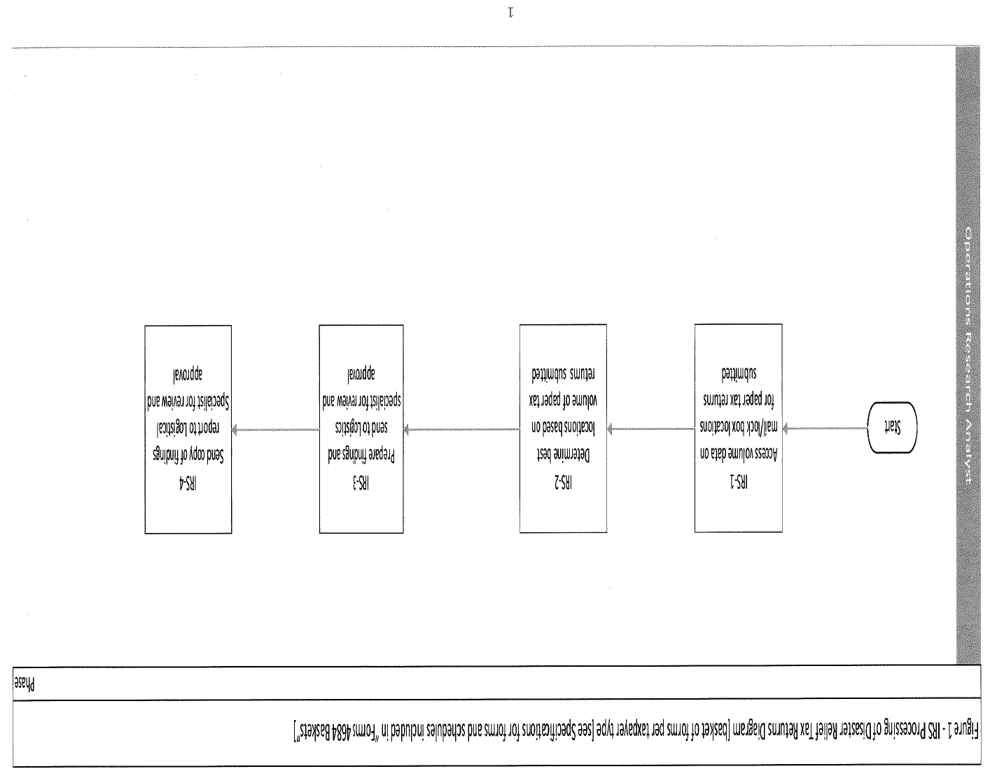

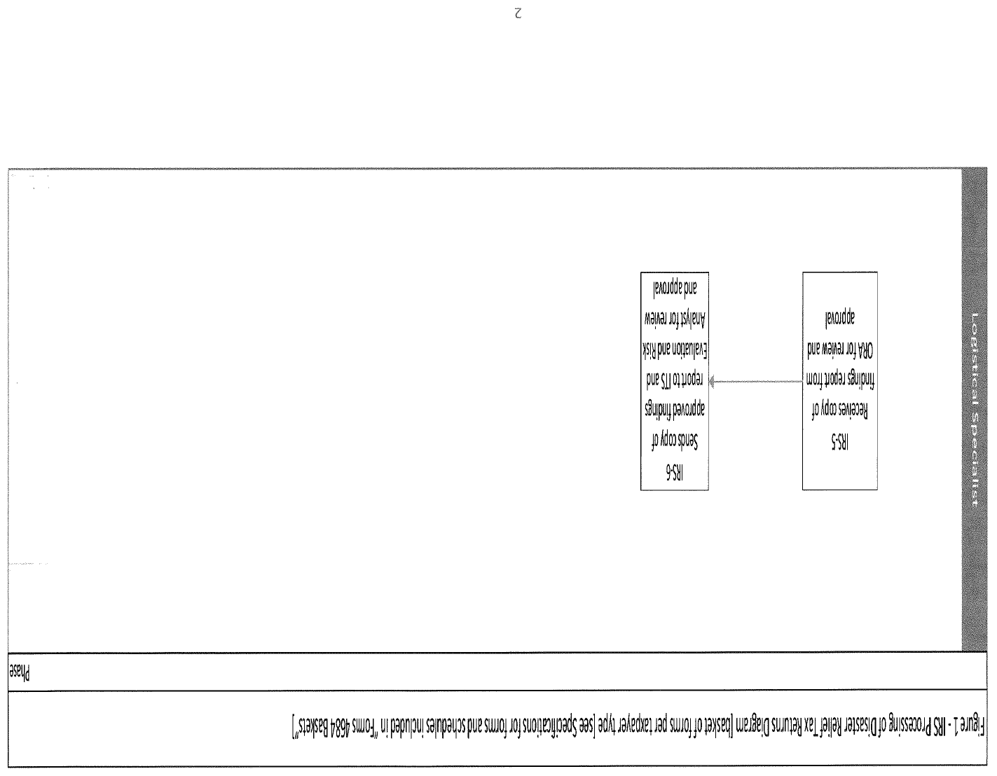

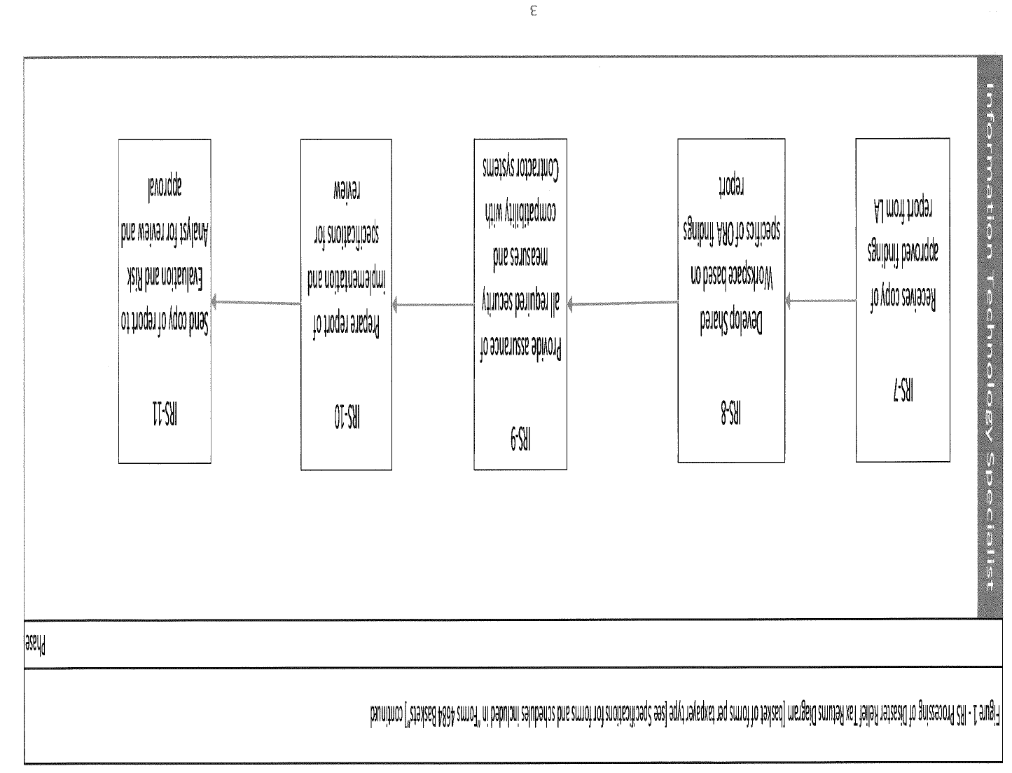

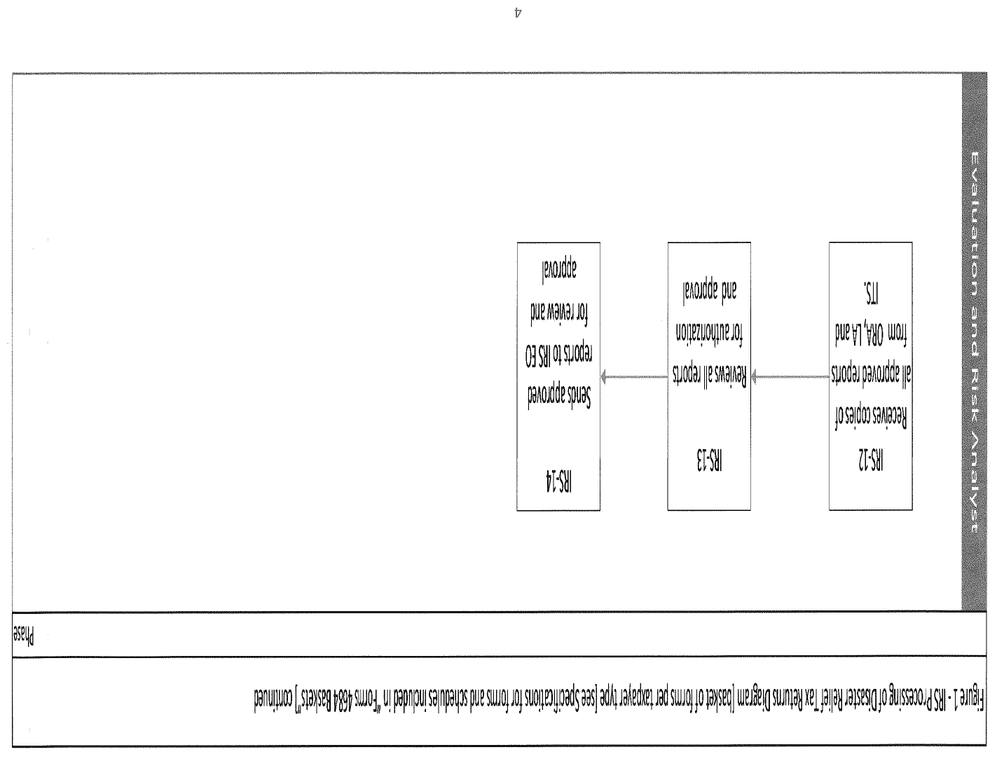

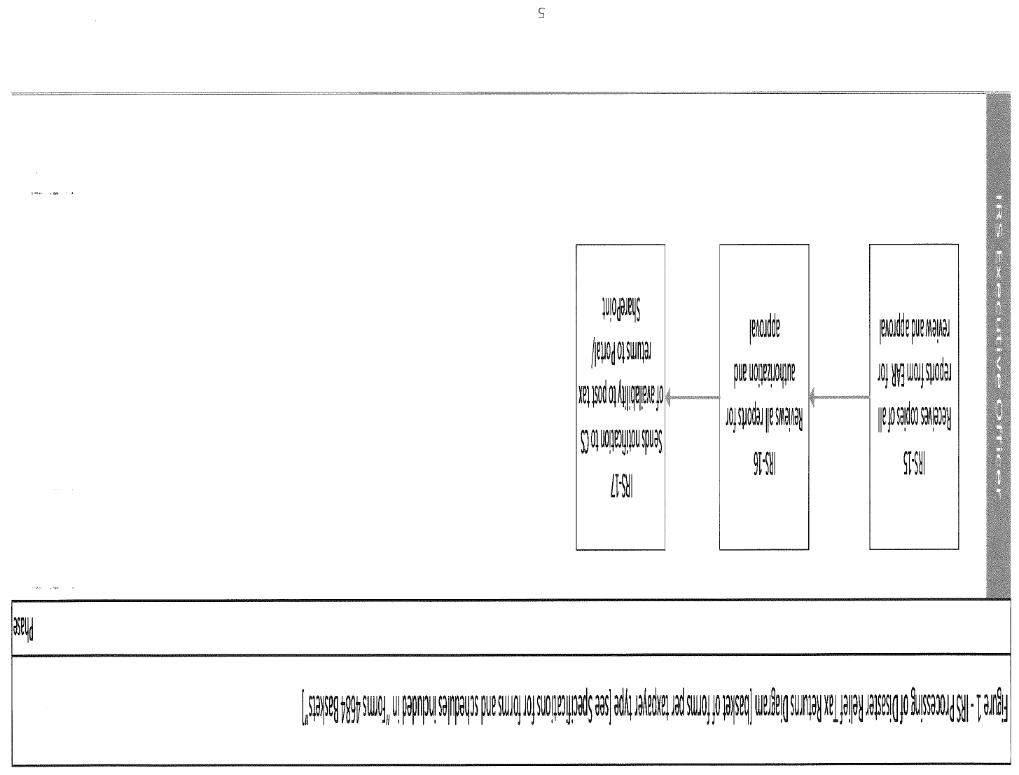

1. FIG. 1 shows the IRS participation in the logical and sequential processing of Forms 4684 and other required forms and schedules.

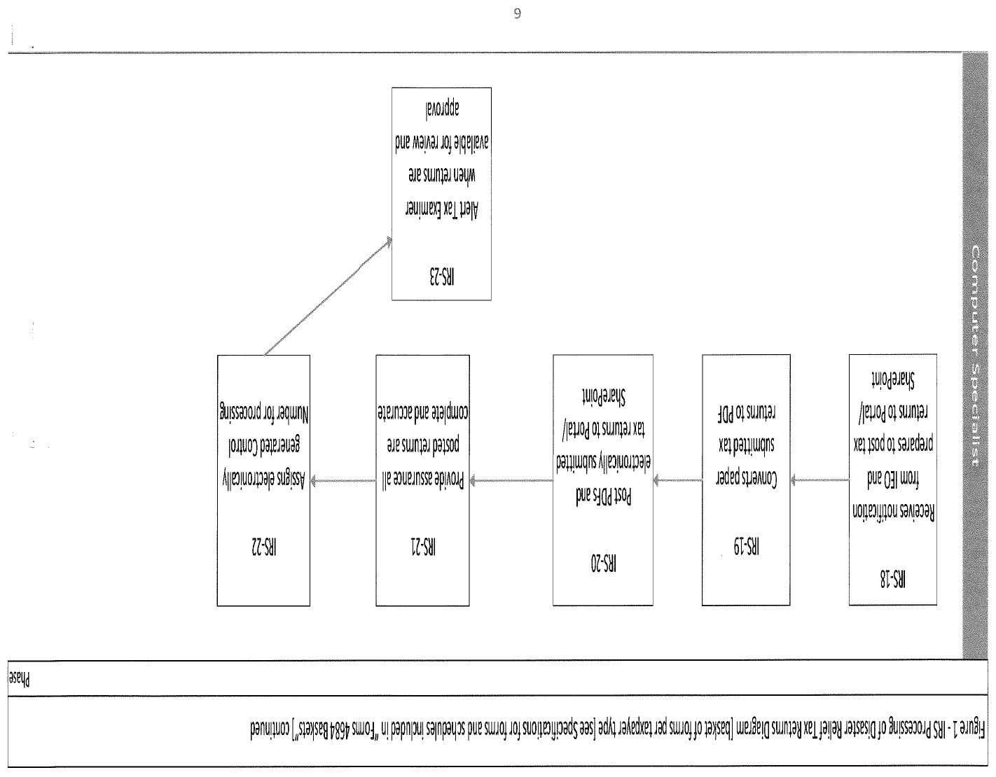

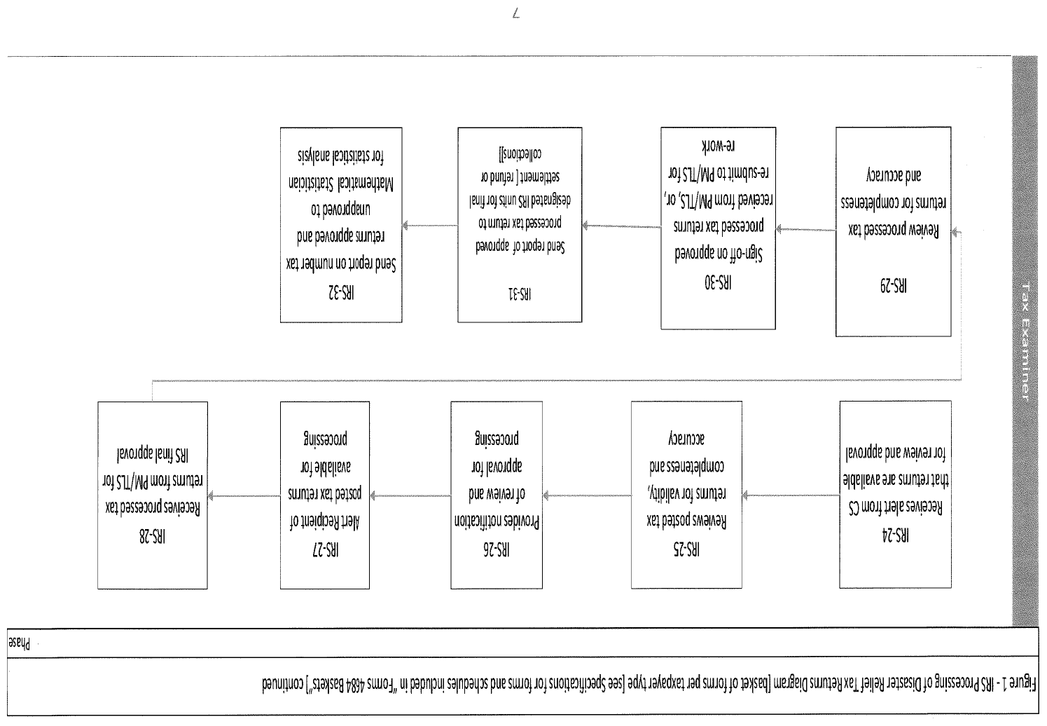

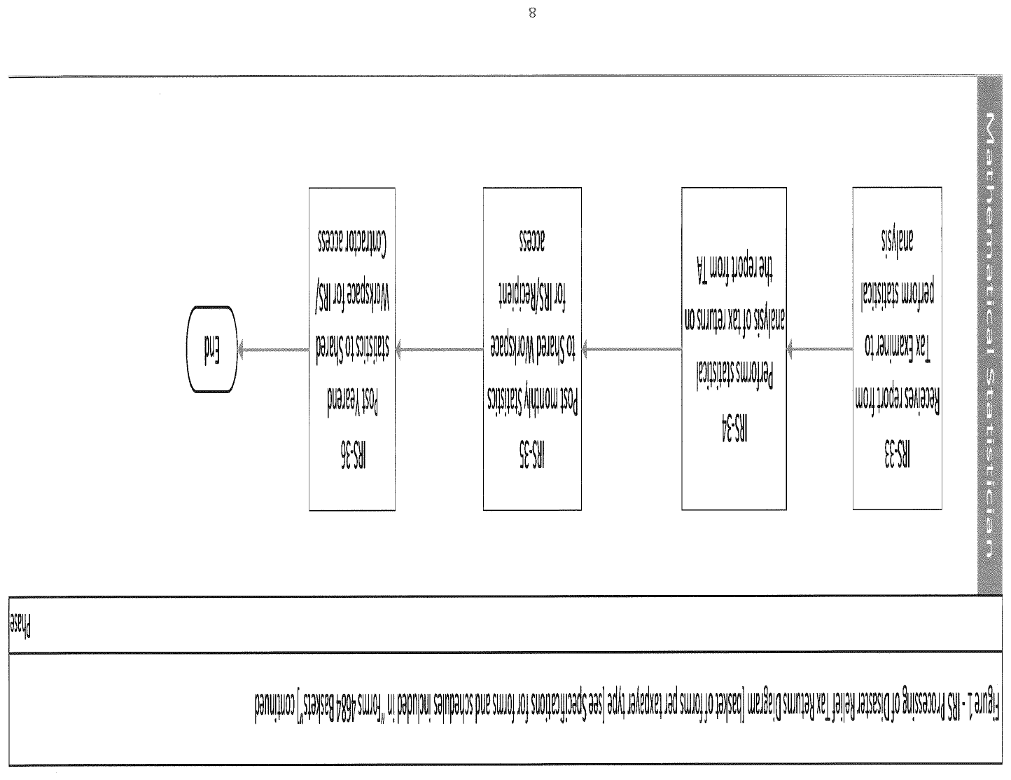

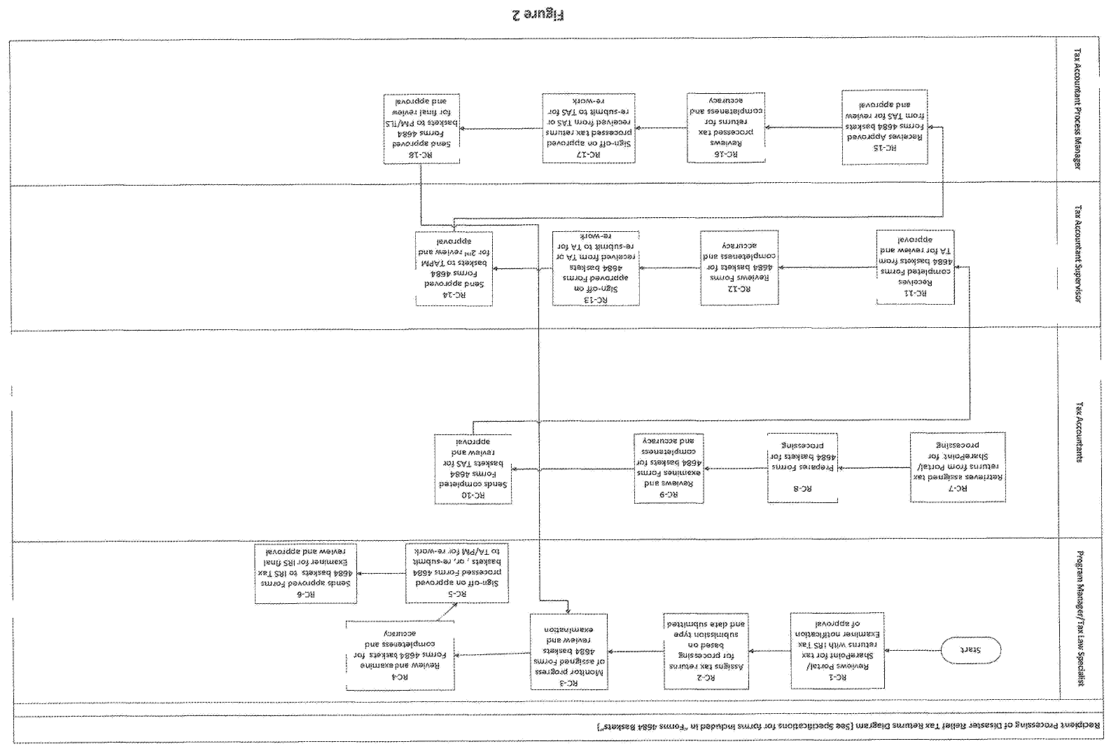

2. FIG. 2 shows the Recipient participation in the logical and sequential processing of Forms 4684 and other required forms and schedules.

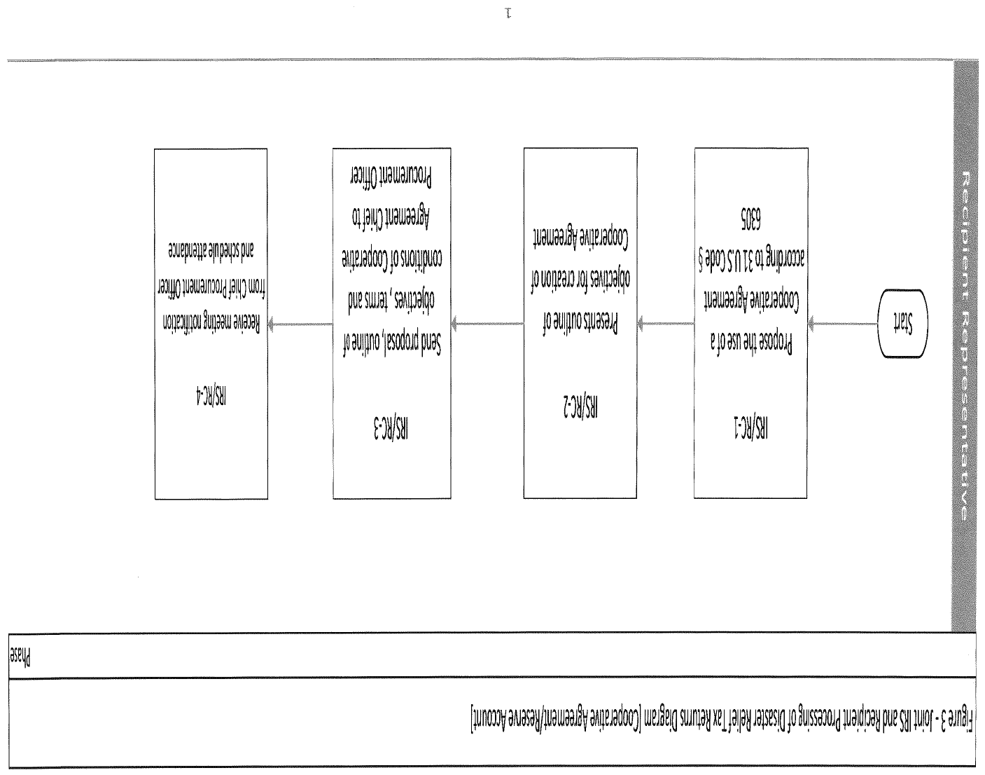

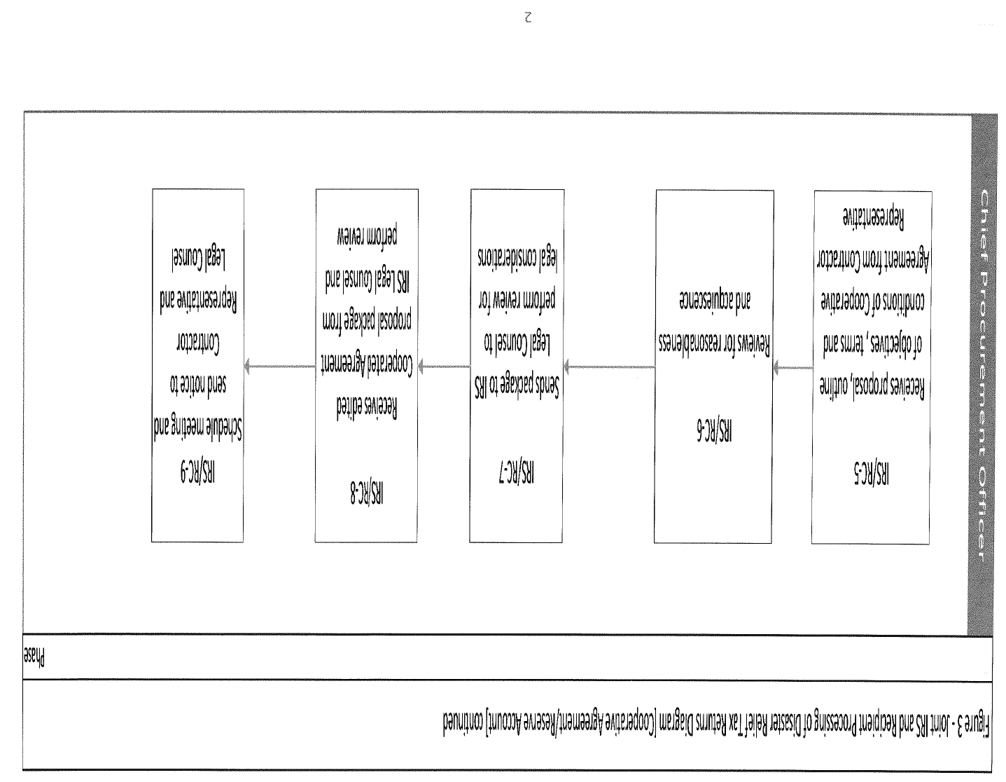

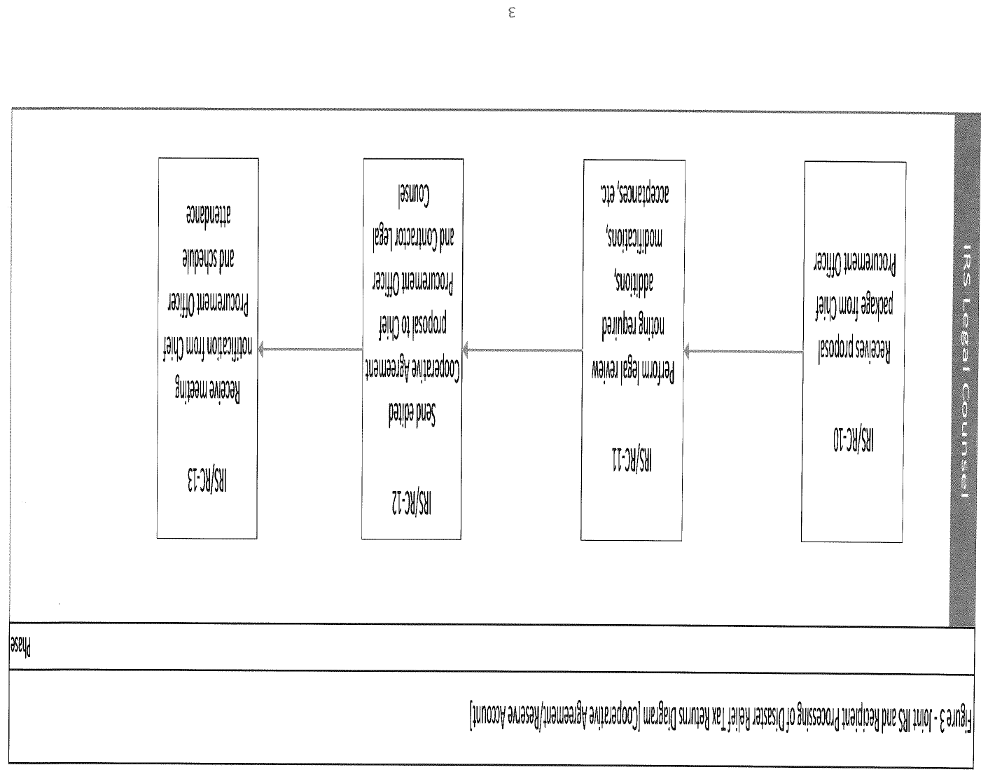

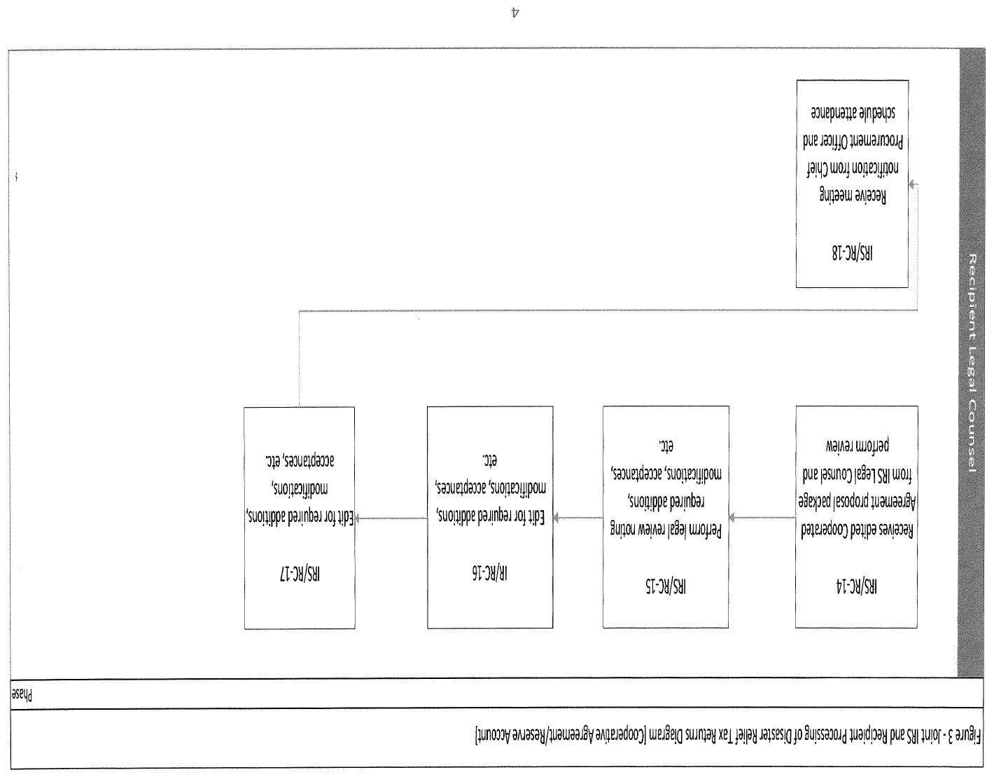

3. FIG. 3 shows the IRS/Recipient joint participation in creating the Cooperative Agreement defining the IRS's and the Recipient's agreed upon level of participation.

### DETAILED DESCRIPTION OF THE INVENTION

### Receiving Tax Returns

### Receipt of Paper Tax Returns and Other Required Forms and Schedules.

4. IRS/Recipient establishes Mailing Addresses/Lock boxes based upon areas frequency of Federal declared casualties, disasters, and thefts.

5. IRS receives tax documents and performs general review for authentication, and completeness.

6. IRS assigns Control Number per set of tax documents.

7. IRS redacts Social Security Number and any other personally identifiable information, as required.

8. IRS converts paper tax documents into PDFs.

9. IRS creates a shared workspace for IRS and Recipient access to tax returns.

10. IRS posts PDF of mailed tax returns to Shared Workspace with notification of their review/approval for processing.

11. IRS then alerts the Recipient of file processing availability.

### Receipt of Electronic Tax Returns and Other Required Forms and Schedules

12. Portal/SharePoint is also used by the IRS and Recipient for access electronically submitted tax returns.

13. IRS performs general review for authentication, and completeness.

14. IRS assigns Control Number.

15. Tax software should redact the Social Security Number. If not, IRS redacts Social Security and any other PII before posting to Shared Workspace.

16. IRA posts electronic electronically submitted tax returns to Shared Workspace with notification of their review/approval for processing.

17. IRS alerts the Recipient of file processing availability.

### Processing Paper Tax Returns Submitted

18. Recipient retrieves PDF for paper tax returns submitted tax returns from Portal/SharePoint and reviews for the IRS notification of approval for processing, and, performs the following steps:

19. Recipient assembles Forms 4684 baskets comprised of Forms 4684 and other essential tax forms and schedules as required for review and examination. The baskets are comprised of standard forms 4684, 4797, 8949; lead forms 1040, 1120, 1120s and 1065 and as amended; and, schedules A, D, K and K-1.

20. Reviews and examines tax forms and schedules [Forms 4684 Baskets] for completeness and accuracy and enters data into tax software for processing.

21. Compares drafted tax forms and schedules to tax forms and schedules originally posted to the shared workspace for completeness and accuracy, noting any deviations.

22. Prepares transmittal with forms attached and conclusion for supervisor review, approval and sign-off.

23. Post transmittal with forms attached and supervisor sign-off to process manager for second review, approval and sign-off.

24. Post transmittal with forms attached and process manager sign-off to program manager for final review, approval and sign-off.

25. After approval by the program manager, the tax returns are posted to the Portal/Repository as complete and available for IRS final review, approval, and settlement with taxpayer.

### Processing Electronic Tax Returns Submitted

26. Recipient retrieves electronically y submitted tax returns from Portal/SharePoint and reviews for the IRS notification of approval for processing, and, performs the following steps:

27. Reviews for required tax forms and enters data into tax software for processing.

28. Compares drafted tax forms and schedules to electronically submitted tax forms for completeness and accuracy.

29. Prepares transmittal with forms attached and conclusion for supervisor review, approval and sign-off.

30. Post transmittal with forms attached and supervisor sign-off to process manager for second review, approval and sign-off.

31. Post transmittal with forms attached and process manager sign-off to program manager for final review, approval and sign-off.

32. After approval by the program manager, the tax returns are posted to the Portal/Repository as complete and available for IRS final review, approval, and settlement with taxpayer.

33. Completed copies of the Forms 4684 [basket] are stored and archived on the Portal/SharePoint for maintenance and retrieval.

### Probabilistic and Non-Probabilistic Analyses

### Probabilistic Analyses

34. Statistical analysis of occurrences per service center, county, state, and region.

35. Statistical analysis of success/error rates per hand-off during processing: tax accountants to supervisor to process manager to program manager.

### Non-Probabilistic Analyses

36. Number of Forms and Schedules processed per service center, county, state, and region.

37. Dollar Amount of Forms and Schedules processed per service center, county, state, and region.

38. Number of Forms 4684 submitted requiring other Forms and Schedules per service center, county, state, and region.

### Creation and Maintenance of Reserve Account

39. Propose creation of cooperative agreement to establish terms legally agreed to by IRS and Contractor.

40. IRS and Recipient consults with legal counsels, mathematical statistician, financial advisor, etc. to establish a clause in the cooperative agreement for joint and severable contributions to achieve self-sustainability.

### Periodic Reporting on Performance and Status for Processing, Invoicing, and Reserve Account

To be determined.

41. A method for processing “Forms 4684 Baskets” comprised of Forms 4684 and other essential and required tax forms and schedules:
a. Forming a procedure for the receipt of mailed and electronically submitted tax forms and schedules by forming a network of mailing addresses and lockboxes.
b. Forming a procedure for posting mailed and electronically submitted tax returns by forming a shared workspace.
c. Forming a procedure for the maintenance of tax forms and schedules by forming a set of directories and folders on the shared workspace.
d. Forming a procedure for the review, examination, and approval of processed tax forms and schedules by forming a review, examination, and approval sub-process.
e. Forming a procedure for performing probabilistic and non-probabilistic analyses, and periodic reporting on overall task performance and status, invoicing, and progress on revolving account.

42. The method of claim 41), wherein the IRS and the Recipient jointly design the network of addresses and lockboxes.

43. The method of claim 41), wherein the network of addresses and lockboxes is determined pursuant to the geographical areas with the highest incidences of Federally declared casualties, disasters, and thefts.

44. The method in claim 41), wherein mailed tax forms and schedules are converted to PDF, and, then, along with electronically submitted tax forms and schedules are posted to a shared workspace.

45. The method of claim 41), wherein the tax forms and schedules are reviewed, redacted, and assigned a Control Number by IRS staff, and approved for review and examination by the Recipient.

46. The method of claim 41), wherein the recipient creates the “Forms 4684 Baskets” and reviews and examines the tax forms through a set of procedures to assure completeness and accuracy, and, sends notice of completion to IRS for final review, approval, and settlement.

47. The method of claim 41) wherein the monitoring of the progress is done through a set of directories or folders as “Received”, “In-Process”, “Requiring Further Review and Examination”, and, “Completed”.

48. The method of claim 41), wherein a set of procedures and steps are placed in service to perform probabilistic and non-probabilistic analyses such as statistical and data analysis to assess and report on task performance, status, invoicing, and status of revolving account.

49. A method to achieve self-sustainability comprised of the legal execution of a Cooperative Agreement between the IRS and the Recipient.

50. The method of claim 49), wherein the IRS and the Recipient agree to make severable and/or joint contributions from the IRS's cost savings and the Recipient's profits to move this method of operations towards self-sustainability.

51. The method of claim 49), wherein the IRS and the Recipient agree to establish periodic reviews of the status of the revolving account to gauge progress and identify required adjustments.
